(19) United States
(12) Patent Application Publication
(10) Pub. No.: US 2025/0373296 A1
(43) Pub. Date: Dec. 4, 2025

(54) METHOD AND SYSTEMS FOR CSI REPORTING ENHANCEMENT FOR TYPE II PMI PREDICTION

(71) Applicant: TELEFONAKTIEBOLAGET LM ERICSSON (pub), Stockholm (SE)

(72) Inventors: Xinlin Zhang, VÄSTRA FRÖLUNDA (SE); Fredrik ATHLEY, VÄSTRA FRÖLUNDA (SE); Siva MURUGANATHAN, STITTSVILLE (CA); Mattias FRENNE, UPPSALA (SE); Roy TIMO, KUNGSÄNGEN (SE)

(73) Assignee: TELEFONAKTIEBOLAGET LM ERICSSON (pub), Stockholm (SE)

(21) Appl. No.: 18/707,866

(22) PCT Filed: Nov. 9, 2022
(86) PCT No.: PCT/IB2022/060802

§ 371 Date: May 6, 2024

Related U.S. Application Data
(60) Provisional application No. 63/277,583, filed on Nov. 9, 2021.
(60) Provisional application No. 63/277,539, filed on Nov. 9, 2021.

(51) Int. Cl. H04B 7/06

(52) U.S. Cl. CPC H04B 7/0626; H04B 7/0634; H04B 7/0658

(57) ABSTRACT

A method performed by a user equipment (UE) for CSI reporting is provided. The method comprises receiving (1002) a configuration of CSI reference signal (CSI-RS) resources for channel measurements and performs (1006) the channel measurements on the CSI-RS resources according to the received configuration. The method further comprises determining (1008) one of: (1) a set of spatial domain basis vectors, a set of frequency domain basis vectors, a set of combination coefficients for combining the set of spatial domain basis vectors and the set of frequency domain basis vectors, and a time-domain information; or (2) a set of spatial domain basis vectors, a set of frequency domain basis vectors, and a plurality of sets of combination coefficients per layer for combining the set of spatial domain basis vectors and the set of frequency domain basis vectors. The method further comprises sending (1016) a CSI report to the network node.

### CROSS REFERENCE TO RELATED APPLICATION

This application claims priority to U.S. Provisional Patent Application No. 63/277,539 and U.S. Provisional patent Application No. 63/277,583, both filed on Nov. 9, 2021, and titled “CSI REPORTING ENHANCEMENT FOR TYPE II PMI PREDICTION.” The contents of both applications are hereby incorporated by reference in their entirety for all purposes.

### FIELD

This present disclosure relates to reporting Channel State Information (CSI) in a wireless communication system.

### BACKGROUND

Multi-antenna techniques can significantly increase the data rates and reliability of a wireless communication system. The performance can be improved if both the transmitter and the receiver are equipped with multiple antennas, which results in a multiple-input multiple-output (MIMO) communication channel. Such systems and/or related techniques are commonly referred to as MIMO. If the same block of spectrum is shared among multiple users, the technology is referred to as MU-MIMO.

Codebook based precoding is a method to receive CSI from user equipment (UE). Type II codebooks are used to support MU-MIMO. Type II codebooks offer predefined precoders for the UE to choose. The UE selected precoders are sent to the network node (e.g., gNB) for calculating the downlink (DL) precoder.

### SUMMARY

Various computer-implemented systems, methods, and articles of manufacture for CSI reporting are described herein.

In one embodiment, a method performed by a UE for CSI reporting is disclosed. The method comprises receiving a configuration of one or more CSI reference signal (CSI-RS) resources for channel measurements and performs the channel measurements on the one or more CSI-RS resources according to the received configuration. The method further comprises determining one of: (1) a set of spatial domain basis vectors, a set of frequency domain basis vectors, a set of combination coefficients for combining the set of spatial domain basis vectors and the set of frequency domain basis vectors, and time-domain information; or (2) a set of spatial domain basis vectors, a set of frequency domain basis vectors, and a plurality of sets of combination coefficients per layer for combining the set of spatial domain basis vectors and the set of frequency domain basis vectors for one or more time steps. The method further comprises sending a CSI report to the network node, the CSI report comprising an indication of one of the set of combination coefficients and an indication of the time-domain correlation matrix, and, an indication of the plurality of sets of combination coefficients per layer for the one or more time steps.

In one embodiment, a UE, comprising processing circuitry is configured to perform the method above.

In one embodiment, a method performed by a network node for receiving a CSI report is disclosed. The method comprises sending, to a UE, a configuration of CSI reference signal (CSI-RS) resources for channel measurements; and receiving a CSI report from the UE. The CSI report comprises one of (1) an indication of a set of spatial domain basis vectors, an indication of a set of frequency domain basis vectors, an indication of a set of combination coefficients for combining the set of spatial domain basis vectors and the set of frequency domain basis vectors, and an indication of a time-domain correlation matrix, or (2) an indication of a set of spatial domain basis vectors, an indication of a set of frequency domain basis vectors, and an indication of a plurality of sets of combination coefficients per layer for combining the set of spatial domain basis vectors and the set of frequency domain basis vectors for one or more time steps.

In one embodiment, a network node, comprising processing circuitry is configured to perform the method above.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an exemplary wireless network in accordance with some embodiments.

FIG. 2 illustrates an exemplary user equipment in accordance with some embodiments.

FIG. 3 illustrates an exemplary virtualization environment in accordance with some embodiments.

FIG. 4 illustrates an exemplary telecommunication network connected via an intermediate network to a host computer in accordance with some embodiments.

FIG. 5 illustrates an exemplary host computer communicating via a base station with a user equipment over a partially wireless connection in accordance with some embodiments.

FIG. 6 illustrates an exemplary method implemented in a communication system including a host computer, a base station, and a user equipment in accordance with some embodiments.

FIG. 7 is a block diagram illustrating a spatial multiplexing operation in accordance with some embodiments.

FIG. 8 illustrates an example procedure for a reciprocity based FDD transmission scheme, according to some embodiments.

FIG. 9 illustrates an example of CSI-RS precoding and Type II PMI calculation based on angle-delay reciprocity, according to some embodiments.

FIG. 10 is a flowchart illustrating a method for CSI reporting, according to some embodiments.

### DETAILED DESCRIPTION

Certain aspects of the embodiments contemplated herein will now be described more fully with reference to the accompanying drawings. Embodiments are provided by way of example to convey the scope of the subject matter to those skilled in the art. This concept may be embodied in many different forms and should not be construed as limited to the embodiments set forth herein; rather, these embodiments are provided so that this disclosure will be thorough and complete, and will fully convey the scope of the concept to those skilled in the art.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the invention may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

In various embodiments, the devices, instruments, systems, and methods described herein may be used to provide a novel CSI reporting mechanism that enables a network node to obtain time domain correlation of channel properties. Based on the obtained time domain correlation of channel properties and available Type II PMI up to the current time step, the network node can predict a Type II PMI for a future time step or multiple future time steps. In this disclosure, a time step corresponds to a resolution of one of a plurality of sets of combination coefficients in a time domain. The predicted CSI reduces overhead for obtaining CSI, as well as provides additional robustness toward high mobility UEs.

It is noted that description herein is not intended as an extensive overview, and as such, concepts may be simplified in the interests of clarity and brevity. Any process or method or corresponding steps of any process or method described in this application may be performed in any order and may omit any of the steps in the process. Processes or methods may also be combined with other processes or steps of other processes, in part or in whole. Parts of processes or methods, or corresponding steps may be combined with other parts of processes or methods, or corresponding steps.

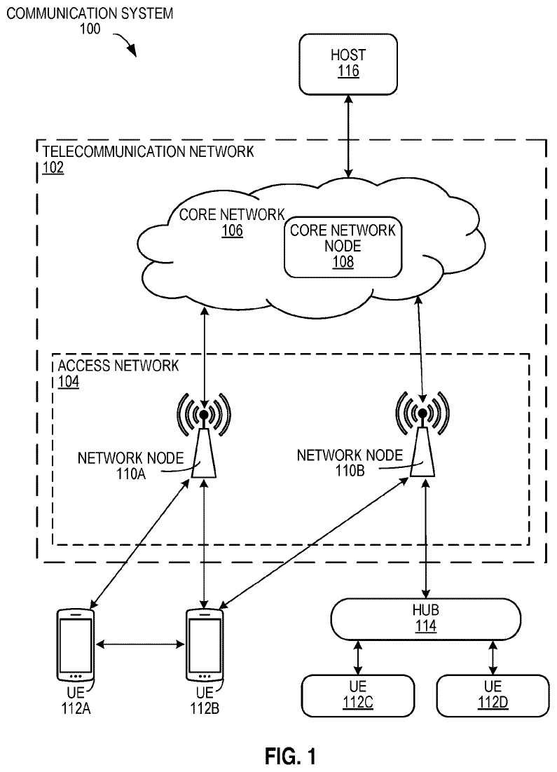

Although the subject matter described herein may be implemented in any appropriate type of system using any suitable components, the embodiments disclosed herein are described in relation to a wireless network, such as the example wireless network illustrated in FIG. 1.

FIG. 1 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) NR-Dual Connectivity (EN-DC).

In the example, the hub 114 communicates with the access network 104 to facilitate indirect communication between one or more UEs (e.g., UE 112c and/or 112d) and network nodes (e.g., network node 110b).

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection.

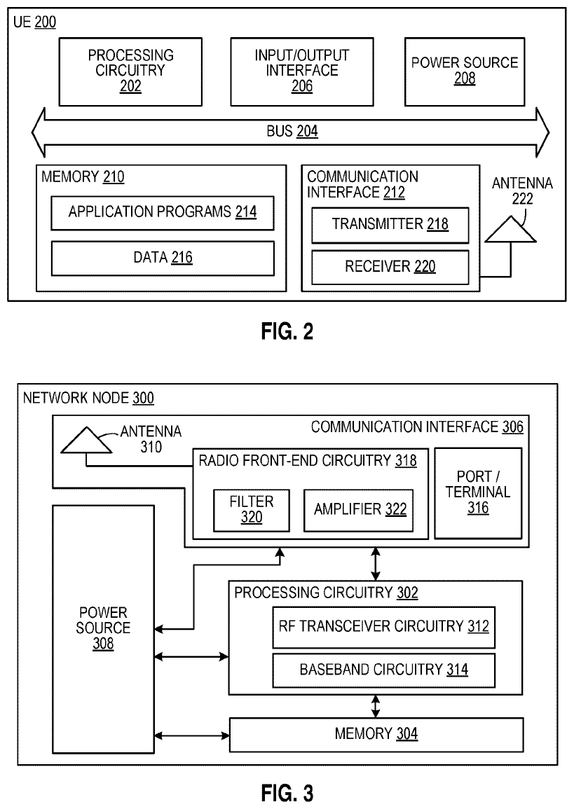

FIG. 2 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

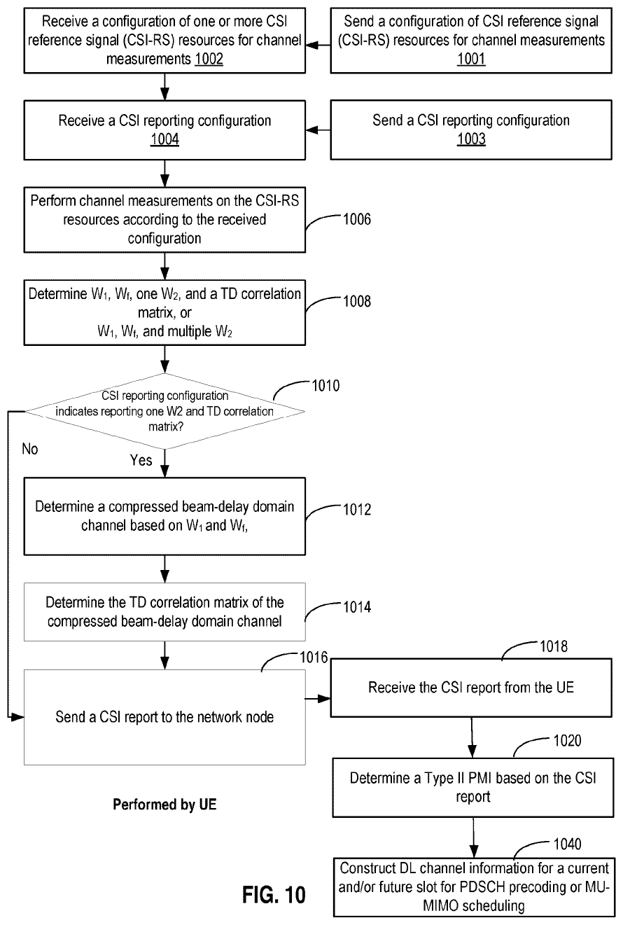

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs). For example, the processing circuitry 202 is configured to perform the steps related to the UE in FIG. 10.

In the example, the input/output interface 206 may be configured to provide an interface or interfaces to an input device, output device, or one or more input and/or output devices.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable ROM (PROM), erasable programmable ROM (EPROM), electrically erasable programmable ROM (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE.

As another example, a UE comprises an actuator, a motor, or a switch, related to a communication interface configured to receive wireless input from a network node via a wireless connection.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone.

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs (NBs), evolved NBs (eNBs) and NR NBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NBs. In such a scenario, each unique NB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality. Further, the processing circuitry 302 is configured to perform the steps related to the network node in FIG. 10.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the RF transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 3 for providing certain aspects of the network node's functionality, including any of the functionality described herein and/or any functionality necessary to support the subject matter described herein.

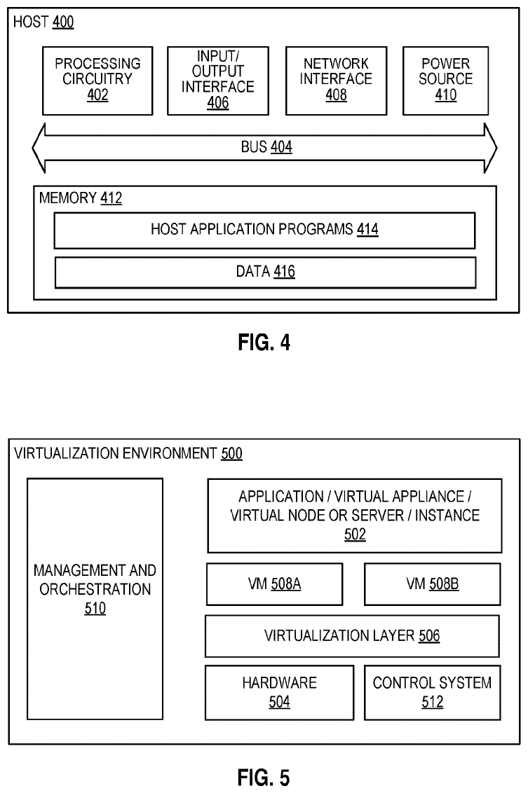

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

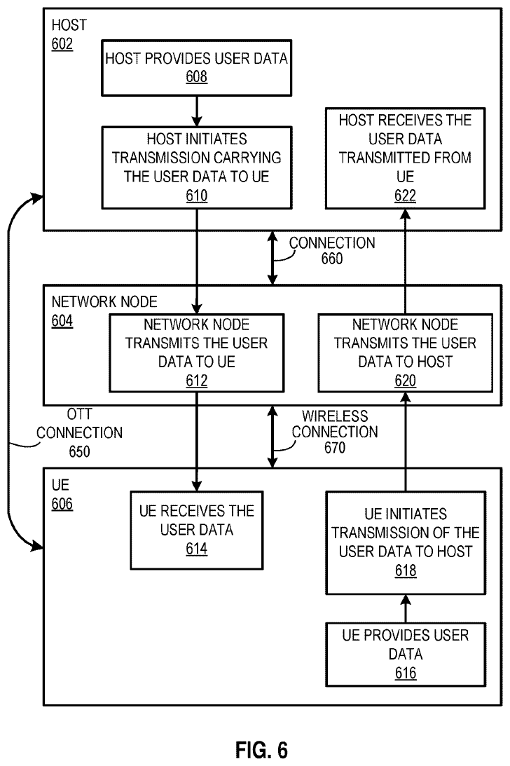

FIG. 6 shows a communication diagram of a host 602 communicating via a network node 604 with a UE 606 over a partially wireless connection in accordance with some embodiments. Example implementations, in accordance with various embodiments, of the UE (such as a UE 112a of FIG. 1 and/or UE 200 of FIG. 2), network node (such as network node 110a of FIG. 1 and/or network node 300 of FIG. 3), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the Type II CSI reporting and enable the network node to predict future a PMI. As a result, the overhead for obtaining CSI is reduced, and enhanced robustness is provided towards high mobility UEs. In turn, this results in improved data rate, latency, power consumption, and better responsiveness among other improvements.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc. In this disclosure, the UEs and network nodes are the same or substantially the same across all figures, even if they have different reference numbers.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

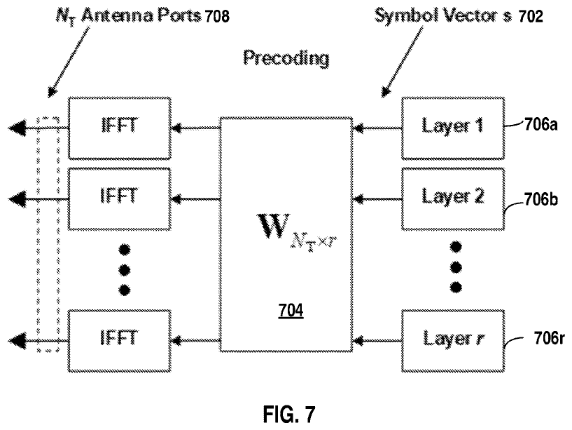

As described above, a core component in NR is the support of MIMO antenna deployments and MIMO related techniques like for instance spatial multiplexing. The spatial multiplexing mode is aimed for high data rates in favorable channel conditions. An illustration of the spatial multiplexing operation is provided in FIG. 7. FIG. 7 is a block diagram for a spatial multiplexing operation. A codebook in the context of CSI-RS is a set of precoders in a precoding matrix. In some embodiments, a codebook matrix transforms the data bit (PDSCH) to another set of data that maps to each antenna port.

As shown in FIG. 7, for precoding, the information carrying symbol vector s 702 is multiplied by an N_{T}×r precoder matrix W 704. The precoder matrix W 704 serves to distribute the transmit energy in a subspace of the N_{T} (corresponding to N_{T} antenna ports 708) dimensional vector space. In some embodiments, the precoder matrix W 704 is selected from a codebook of possible precoder matrices and indicated by means of a precoder matrix indicator (PMI), which specifies a unique precoder matrix in the codebook for a given number of symbol streams. The r symbols in the vector s 702 each corresponds to a layer (e.g., transmission layers 706a-706r) and r is referred to as the transmission rank. In this way, spatial multiplexing can be achieved since multiple symbols can be transmitted simultaneously over the same time/frequency resource element (TFRE). The number of symbols r is typically adapted to suit the current channel properties.

The new radio uses orthogonal frequency-division multiplexing (OFDM) techniques in the downlink (UL) and discrete Fourier Transform (DFT) precoded OFDM in the uplink (UL) for rank-1 transmission. Therefore, the received N_{R}×1 vector yₙ for a certain TFRE on subcarrier n (or alternatively data TFRE number n) is modeled by formula [1] below.

$${y}_{n} = {H}_{n} {Ws}_{n} + {e}_{n} \qquad [ 1 ]$$

In formula [1] above, eₙ denotes a noise/interference vector obtained as realizations of a random process, N_{R} corresponds to the number of antenna ports at the receiver. The precoder matrix W 704 can be a wideband precoder, which is constant over frequency, or a frequency selective.

The precoder matrix W 704 is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the UE.

In closed-loop precoding for the NR DL, the UE transmits, based on channel measurements in the DL, recommendations to the gNB of a suitable precoder to use. For example, the network node configures the UE to provide feedback according to a CSI reporting configuration (e.g., CSI-ReportConfig) and may transmit CSI-RS and configures the UE to use measurements of CSI-RS to feedback recommended precoding matrices that the UE selects from a codebook. A single precoder that is supposed to cover a large bandwidth (wideband precoding) may be fed back. It may also be beneficial to match the frequency variations of the channel and instead provide feedback as a frequency-selective precoding report (e.g., several precoders, one per sub-band). This is an example of the more general case of CSI feedback, which also encompasses feeding back information other than recommended precoders to assist the network node in subsequent transmissions to the UE. Such other information may include channel quality indicators (CQIs) and transmission rank indicator (RI). In NR, CSI feedback can be either wideband, where one CSI is reported for the entire channel bandwidth, or frequency-selective, where one CSI is reported for each sub-band, which is defined as a predetermined number of contiguous resource blocks ranging between 4-32 PRBS depending on the bandwidth part (BWP) size.

Provided with the CSI feedback from the UE, the network node determines the transmission parameters it intends to use to transmit to the UE, including the precoding matrix, transmission rank, and modulation and coding scheme (MCS). These transmission parameters may differ from the recommendations by the UE. The transmission rank, and thus the number of spatially multiplexed layers, is reflected in the number of columns of the precoder matrix W 704. For efficient performance, a transmission rank that matches the channel properties is selected. For more information, see details in TS. 38.214.

In a Frequency-division duplexing (FDD)-based reciprocity operation, the UL and DL transmissions are carried out on different frequencies. Thus, the propagation channels in UL and DL are not reciprocal as in the TDD case. However, some physical channel parameters such as angle of arrival/departure and the associated delays depend on only the spatial properties of the channel and are generally reciprocal between UL and DL. Such properties are exploited in NR Rel-17 enhanced Type II port selection codebook for DL channel state information (CSI) feedback, where the channel delay and angle information obtained in the UL is used to precode and delay-compensate CSI reference signals such that DL CSI can be fed back with much less overhead.

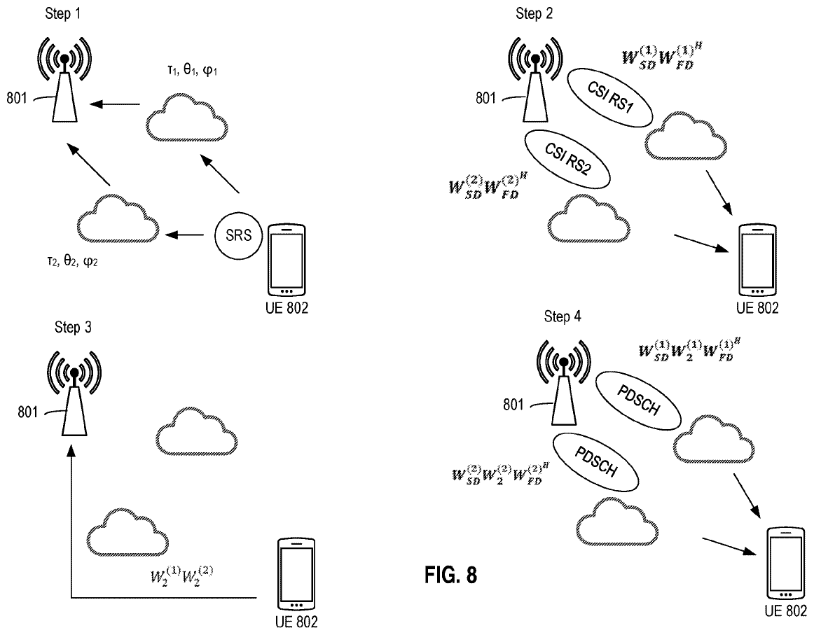

One example procedure for a reciprocity based FDD transmission scheme is illustrated in FIG. 8. In FIG. 8, UE 802 corresponds to any of the UEs described in the previous figures (e.g., UE 112A or 112B), and network node 801 corresponds to any network node described in the previous figures (e.g., network node 110A or 110B).

With reference to FIG. 8, at step 1, UE 802 is configured with a sound reference signal (SRS) by the network node 801. UE 802 transmits the SRS in the UL to the network node 801. Network node 801 estimates the angles and associated delays of different multipath channel clusters, which are associated with different propagation paths.

At step 2, the network node 801 selects dominant clusters according to the estimated angle-delay power spectrum profile. Based on the estimated angle-delay power spectrum profile, a set of spatial-domain (SD) basis vectors (or beams) and a set of delays are computed by the network node 801 for CSI-RS precoding or beamforming. For each beam (or SD basis vector) and delay pair, a CSI-RS port is allocated. Network node 801 applies a precoder (which is the SD basis vector) and a delay pre-compensation to each of the CSI-RS ports in a configured CSI-RS resource or multiple CSI-RS resources to UE 802 such that all the CSI-RS reach the UE at the same time.

At step 3, network node 801 has configured UE 802 to measure the channel based on the received CSI-RS, and UE 802 measures the received CSI-RS ports and then determines a type II CSI including RI (rank indicator), PMI (precoding matrix indicator) for each layer, and CQI (channel quality indicator). The precoding matrix indicated by the PMI includes a set of UE selected CSI-RS ports out of the configured CSI-RS ports and one or more frequency domain (FD) basis vectors out of a full set of FD basis, where each FD basis corresponds to a channel delay. Ideally, if the channel consists only a set of discrete propagation paths with well separated the angles and delays, all the CSI-RS would be time aligned at the UE and there would be only a single FD basis is needed. However, due to limited number of CSI-RS ports and the channel multipath may not be well separated, the CSI-RS received at the UE may not be able to be represent by a single delay or FD basis vector. Therefore, more than one FD basis vector may be needed. The precoding matrix further comprises the corresponding phase and amplitude for the selected CSI-RS ports (or beams) and the FD basis vectors. The phase and amplitude are quantized and sent back to network node 801 as part of a type II CSI report.

At step 4, network node 801 computes a DL precoding matrix per layer based on the UE reported beams or CSI-RS ports, FD basis vectors, and the corresponding amplitudes and phases, and applies the precoding matrix (or precode) to Physical Downlink Shared Channel (PDSCH) transmission. The transmission can be based on the fed-back precoding matrices directly (e.g., SU-MIMO transmission), or the transmission precoding matrix is obtained by considering CSI feedback from multiple co-scheduled UEs (MU-MIMO transmission) where the precoder could be derived based on the precoding matrices including the CSI reports from co-scheduled UEs (for example, a Zero-Forcing (ZF) precoder or a regularized ZF precoder). The final precoder is commonly scaled so that the transmit power per power amplifier is not overridden.

As described above, FIG. 8 is a diagram illustrating a procedure of codebook-based transmission for FDD with delay and angle reciprocity between DL and UL. Such reciprocity-based transmission can potentially be utilized in a codebook-based DL transmission for FDD to, for example, reduce the feedback overhead in UL when NR Rel-17 enhanced Type II port-selection codebook is used. Another potential benefit is reduced complexity in the CSI calculation performed by UE 802. It is understood that As described above, 8 only illustrates one example of the procedure for FDD-based reciprocity operation, where each CSI-RS port contains a single SD basis and FD delays pair. In some embodiments, each CSI-RS port may contain multiple SD-FD basis pairs, and that UE 802 can compress the channel with more FD components besides the DC DFT component.

Based on the angle and delay reciprocity, network node 801 can determine a set of dominant clusters in the propagation channel by analyzing the angle-delay power spectrum of the UL channel. Then, network node 801 can utilize this information in a way such that each CSI-RS port is precoded towards a dominant cluster. A dominant cluster in a propagation channel corresponds to one or more strongest peaks in a power spectrum of the channel. The strongest peaks refer to the local maxima in the power spectrum. In addition to SD beamforming, each of the CSI-RS ports will also be pre-compensated in time such that all the precoded CSI-RS ports are aligned in the delay domain. As a result, frequency-selectivity of the channel is removed and UE 802 observes a frequency-flat channel, which requires very small number of FD basis vectors to compress. If all the beams can be perfectly aligned in time, UE 802 performs a wideband filtering to obtain all the channel information, based on which UE 802 can calculate the Rel-17 Type II PMI. Even if delay cannot be perfectly pre-compensated at network node 801, the frequency selectively seen at UE 802 can still be greatly reduced, so that UE 802 uses a much smaller number of FD basis vectors to compress the channel.

In summary, in NR Rel-17 type II port selection codebook, the precoding matrix for each layer can be expressed as

$${W}^{l} = {W}_{1} {W}_{2 , l} {W}_{f}^{H} ,$$

where is a CSI-RS port selection matrix of size N by 2L with each column containing one element of integer one and the rest of the elements of zeros, W_{f} is a DFT matrix of size N3 by M, representing the selected FD basis vectors for layer l, and W_{2,l} is a 2L by M coefficient matrix with each of its element representing the coefficient for a corresponding pair of selected SD and FD basis vectors, N is the number of configured CSI-RS ports, L is the configured ports or beams to be selected, N3 is the number of PMI subbands, and M is the number of FD basis vectors to be selected. For ease of discussion, the layer index l may be dropped from the matrices in the following sections.

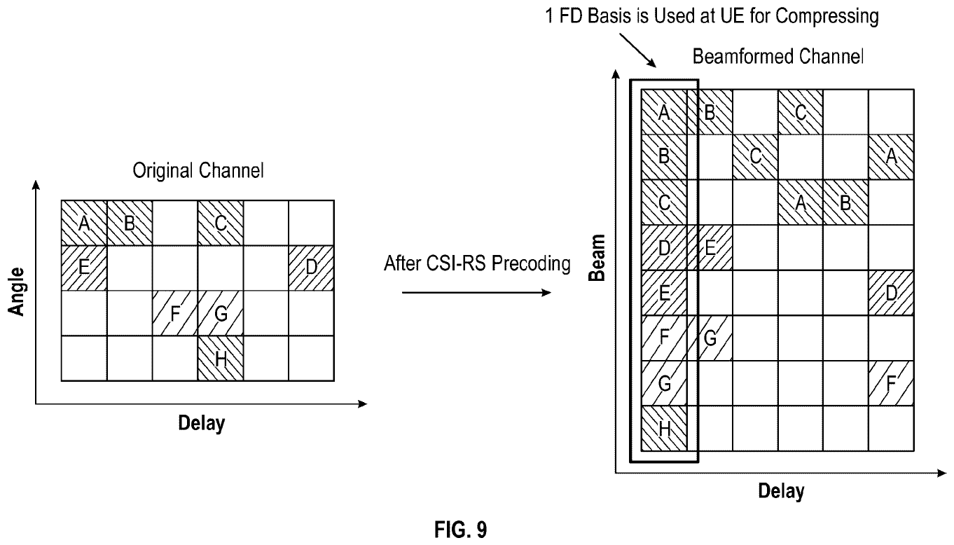

The above procedure is further explained by an example in FIG. 9. Based on UL measurement, network node 801 identifies eight dominant clusters that exist in the original channel, tagged as A-G, which are distributed in four directions, with each direction containing one or more taps (i.e., discrete delays). In this example, eight CSI-RS ports are precoded at network node 801. Each CSI-RS port is precoded towards a dominant direction with pre-compensated delay for a given cluster. As one example, the delay compensation can be realized by applying a linear phase rotation across occupied subcarriers. As a result, in the beamformed channel, which is seen at UE 802, all the dominant clusters are aligned at the same delay (equivalent to a frequency flat channel). Therefore, UE 802 applies a wideband filter. For example, UE802 applies the DC component of a DFT matrix (i.e., W_{f} containing a single vector where all elements in the vector has the value “one”) to compress the channel and preserve all the channel information. Based on the compressed channel, the UE 802 calculates W₁ (spatial domain basis vectors for selected CSI-RS ports) and W₂ (complex coefficients for combining selected ports), which are the remaining part of the Type II port selection codebook.

FIG. 9 described above illustrates only an example of CSI-RS precoding and Type II PMI calculation based on angle-delay reciprocity.

As described above, the UE may move from one place to another and may move in a low, medium, or high velocity. The relative motion between a transmitter and a receiver results in a Doppler shift which is the change in frequency of a wave in relation to an observer who is moving relative to the wave source. The Doppler spread, which is a measure of the spectral broadening caused by the time rate of change of the mobile radio channel, can also be defined as the range of frequencies over which the received Doppler spectrum is essentially non-zero.

Assuming that the bandwidth of the transmitted signal is very small compared to the carrier frequency f_{c}, a signal component making an angle of θ with the direction of motion of the receiver results in a Doppler shift of

$${f}_{D} = {f}_{c} \cdot ( \frac{ν}{c} ) \cdot cos θ ,$$

where v denotes the relative speed of the receiver, and c denotes the speed of light in free space. The maximum possible Doppler shift,

$${f}_{D , max} = {f}_{c} \cdot ( \frac{v}{c} )$$

is obtained for θ=0 and π. In case of a multi-path propagation, signal components arriving at the receiver from different directions experience different Doppler shifts and the total received signal exhibits a frequency spread around the carrier frequency. The width of the spread around the carrier frequency is referred to as Doppler spread. The precise definition of Doppler spread may vary across literature and f_{D,max} is often used as an approximation for Doppler spread.

The Doppler characteristics of the received signal are captured using the Doppler power spectrum, which is related to the autocorrelation function in time of the time-varying channel through a Fourier transform. Therefore, availability of Doppler power spectrum or its properties allows modeling of the time-variations of a channel. Under the assumption of a propagation environment where a receiver is surrounded by infinite scatterers uniformly distributed in a circle, the autocorrelation function in time is a Bessel function of the first kind with f_{D,max} as an argument. In this scenario, an estimate of the maximum Doppler shift alone enables approximating the autocorrelation in time.

The term “Doppler information” or “Doppler parameter(s)” described herein refers to one or many of, e.g., Doppler shift, Doppler spread, and Doppler spectrum. Doppler information or parameter(s) can be used to describe the time domain channel characteristics.

Channel prediction can be performed with Kalman filter. The Kalman filter is a recursive estimator, which means that only the estimated state from the previous time step and the measurement at the current time step are needed to compute the estimate for the current state. Typically, the Kalman filter can be decomposed into two steps: a prediction step and an update step, which are further explained below.

The prediction step is performed as follows. The Kalman filter assumes that the true state at time step n is evolved from time step n-1 according to the following formula.

$${x}_{n} = {Ax}_{n - 1} + {Bu}_{n} + {w}_{n} \qquad [ 2 ]$$

In the above formula [2], A denotes a state transition model that does not change over time for wide sense stationary processes, wₙ denotes the complex Gaussian distributed process noise with zero mean and covariance Q_{w}. The covariance Q_{w} reflects the confidence in prediction accuracy: a larger variance means less confidence in the prediction due to higher uncertainty, and vice versa. The terms B and uₙ are the control-input model and the control vector, respectively. Typically, they can be assumed known.

The prediction step uses a state estimate from the previous time step, \hat{x}_{n-1|n-1}, to produce a new state estimate for the current time step, \hat{x}_{n|n-1}. The predicted state estimate \hat{x}_{n|n-1}, also known as the a priori state estimate, is given by the following formula.

$${\hat{x}}_{n \vert n - 1} = A {\hat{x}}_{n - 1 \vert n - 1} + {Bu}_{n} \qquad [ 3 ]$$

The above formula [3] is the maximum likelihood estimate, as the process noise wₙ has zero mean.

Along with predicting the state \hat{x}_{n|n-1}, its covariance can be calculated. The covariance is expressed as

$${P}_{n \vert n - 1} = E ( {\hat{x}}_{n \vert n - 1} {\hat{x}}_{n \vert n - 1}^{H} ) ,$$

with E(⋅) being the expectation operator. The covariance can be calculated using the following formula.

$${P}_{n \vert n - 1} = A {P}_{n - 1 \vert n - 1} {A}^{H} + {Q}_{w} \qquad [ 4 ]$$

The covariance, calculated by the above formula [4], is needed later for the update step.

The update step is based on a noisy measurement yₙ, which is a function of the true state xₙ. The measurement model can be expressed as the following formula.

$${y}_{n} = {Cx}_{n} + {v}_{n} \qquad [ 5 ]$$

In the above formula [5], C is the measurement model that do not change over time for wide sense stationary processes, and vₙ is the measurement noise, which is assumed to be complex Gaussian distributed with zero mean and covariance Qᵥ that is also independent of time.

Based on the measurement yₙ, which contains the true state xₙ, the posteriori state estimate, \hat{x}_{n|n}, is obtained by refining the a priori state estimate, \hat{x}_{n|n-1}, according to:

$${\hat{x}}_{n \vert n} = {\hat{x}}_{n \vert n - 1} + {K}_{n} ( {y}_{n} - C {\hat{x}}_{n \vert n - 1} ) \qquad [ 6 ]$$

In formula [6], the term Kₙ is the so-called optimal Kalman gain, which is given by the following formula.

$${K}_{n} = {P}_{n \vert n - 1} {{C}^{H} ( {CP}_{n \vert n - 1} {C}^{H} + {Q}_{v} )}^{- 1} \qquad [ 7 ]$$

The optimal Kalman gain minimizes the residual error yₙ−C\hat{x}_{n|n-1} in the mean squared sense. In essence, it is the linear minimum mean squared error (LMMSE) estimator.

Along with updating the state estimate, the covariance of the state is also updated according to:

$${P}_{n \vert n} = ( I - {K}_{n} C ) {P}_{n \vert n - 1} \qquad [ 8 ]$$

The above two steps, i.e., the prediction step and the update step, usually alternate, thereby forming a time advanced estimate/predict of the state. However, note that it is possible to skip the prediction or measurement step at times. For example, if a measurement is unavailable for some reason, the update step can be skipped, and multiple prediction procedures can be performed.

The Kalman filter can be applied to predict the channel evolution over time. For this purpose, the control-input model B and control vector uₙ can be dropped for simplicity, which does not affect the optimality for channel prediction problem. Then, the state transition model in the prediction step becomes an auto-regression (AR) model with order 1, i.e., xₙ=Axₙ₋₁+wₙ.

Given that the current state xₙ₋₁ and the state transition model A are both known, it is possible to predict a future state xₙ via the prediction step. In the context of channel prediction, xₙ₋₁ can be considered as the channel known up to time step n-1, which can be approximated by its estimate \hat{x}ₙ₋₁. Then, only the state transition model A is yet to be estimated, which may be estimated using the Yule-Walker equations.

To derive the state transition model A, it can be assumed that an AR (auto-regressive) model with order p is used for predicting the channel as shown in the below formula.

$${\underline{h}}_{n} = {\sum }_{i = 1}^{p} {Φ}_{i} {\underline{h}}_{n - i} + {w}_{n} \qquad [ 9 ]$$

In formula [9], hₙ=vec(Hₙ) denotes the vectorized narrowband channel, Hₙ denotes the narrowband channel between a network node with M antenna ports and UE with N antenna ports at time step n. The AR parameter matrix, Φᵢ, can be estimated using the Yule-Walker equations:

$$[ \begin{matrix}{R}_{1} & {R}_{2} & ⋯ & {R}_{p}\end{matrix} ] = [ \begin{matrix}{Φ}_{1} & {Φ}_{2} & ⋯ & {Φ}_{p}\end{matrix} ] \overline{R} , \qquad [ 10 ]$$

$$where$$

$$\overline{R} = [ \begin{matrix}{R}_{0} & {R}_{1} & ⋯ & {R}_{p - 1} \\ {R}_{1}^{H} & {R}_{0} & ⋯ & {R}_{p - 2} \\ ⋮ & ⋮ & ⋱ & ⋮ \\ {R}_{p - 1}^{H} & {R}_{p - 2}^{H} & ⋯ & {R}_{0}\end{matrix} ] ,$$

and

$${R}_{i} = E [ {\underline{h}}_{n} {\underline{h}}_{n - i}^{H} ]$$

is the auto-correlation matrix of hₙ with lag i. Then, the AR parameters Φᵢ∈ [symbol] ^{MN×MN} can be obtained via

$$[ \begin{matrix}{Φ}_{1} & {Φ}_{2} & ⋯ & {Φ}_{p}\end{matrix} ] = [ \begin{matrix}{R}_{1} & {R}_{2} & ⋯ & {R}_{p}\end{matrix} ] {\overline{R}}^{- 1} .$$

In addition, the covariance matrix of process noise, Q_{w}, can be calculated by the following equation.

$${Q}_{w} = {R}_{0} - {\sum }_{i = 1}^{p} {Φ}_{i} {R}_{i}^{H} . \qquad [ 11 ]$$

The above estimated AR parameters can be related to the state transition model in the Kalman filter prediction step via the following formula.

$${\underline{\tilde{h}}}_{n} = \tilde{Φ} {\underline{\tilde{h}}}_{n - 1} + \tilde{Θ} {w}_{n} \qquad [ 12 ]$$

In formula [12],

$${\underline{\tilde{h}}}_{n} = {[ \begin{matrix}{\underline{h}}_{n}^{T} & ⋯ & {\underline{h}}_{n - p + 1}^{T}\end{matrix} ]}^{T} ∈ {ℂ}^{MNp \times 1} ,$$

which is the state vector obtained by concatenating the vectorized channel for the past p time steps. The state transition matrices \tilde{Φ} for state and \tilde{Θ} for processing noise are given by the following formulas.

$$\tilde{Φ} = [ \begin{matrix}{Φ}_{1} & {Φ}_{2} & ⋯ & {Φ}_{p - 1} & {Φ}_{p} \\ {I}_{MN} & {0}_{MN} & ⋯ & {0}_{MN} & {0}_{MN} \\ {0}_{MN} & {I}_{MN} & ⋯ & {0}_{MN} & {0}_{MN} \\ ⋮ & ⋮ & ⋱ & ⋮ & ⋮ \\ {0}_{MN} & {0}_{MN} & ⋯ & {I}_{MN} & {0}_{MN}\end{matrix} ] ∈ {ℂ}^{MNp \times MNp} , \qquad [ 13 ]$$

$$\tilde{Θ} = [ \begin{matrix}{I}_{MN} \\ {0}_{MN} \\ ⋮ \\ {0}_{MN}\end{matrix} ] ∈ {ℂ}^{MNp \times MN} , \qquad [ 14 ]$$

In the above formulas [13] and [14], I_{MN} and O_{MN} are the identity matrix and zero matrix of dimension MN×MN, respectively.

To summarize, if an AR model of order p is used for prediction, the ML estimate of the channel for time n based on channel estimates at time n-1, n-2, . . . , n-p+1, is given by the following formula.

$${\hat{\tilde{\underline{h}}}}_{n \vert n - 1} = \tilde{Φ} {\hat{\tilde{\underline{h}}}}_{n - 1 \vert n - 1} . \qquad [ 15 ]$$

In a special case where an AR model of order 1 is used, the predicted channel at time step n only depends on the channel at time step n-1, which is expressed in the following expression.

$${\underline{h}}_{n} = {Φ}_{1} {\underline{h}}_{n - 1} \qquad [ 16 ]$$

Type II CSI can be useful for multiple user MIMO (MU-MIMO) transmissions when UEs have high mobility. To predict the Type II CSI, time domain correlation of certain channel properties is needed. Currently, radio access technology lacks mechanisms for obtaining such time domain correlation by a network node. Therefore, a solution is needed for obtaining time domain correlation of channel properties at the network node. After the network node obtains the time domain correlation, it can use the time domain correlation for Type II CSI prediction.

Certain aspects of the disclosure and their embodiments may provide solutions to these or other challenges. The proposed solution includes methods for CSI reporting. To address the aforementioned challenges, the present disclosure includes one or more CSI reporting mechanisms that enable the network node to obtain time domain correlation of channel properties. Based on the obtained time domain correlation of channel properties and available PMI (e.g. Type II PMI) up to the current time step, a network node can predict a PMI (e.g. Type II PMI) for a future time step.

The CSI reporting mechanisms are described in greater details below with reference to FIG. 10. FIG. 10 is a flowchart illustrating a method 1000 for CSI reporting. Some of the steps of method 1300 are performed by a UE (e.g., any UE described above) and some steps of method 1000 are performed by a network node (e.g., any network node described above). As described in this disclosure, an indication can represent one or more indices, representations, messages, or the like.

With reference to FIG. 10, in some embodiments, at step 1001, a network node sends to UE a configuration of CSI reference signal (CSI-RS) resource(s) for channel measurements. The CSI-RS resource(s) may be, for example, NZP CSI-RS resource(s) that span over multiple time steps for channel measurements. Time steps are sometimes also referred to as time instances. At step 1002, the UE receives the configuration of the CSI-RS resource(s) (e.g., NZP) spanning over multiple time instances for channel measurement.

At step 1003, the network node sends a CSI reporting configuration associated with the configured CSI-RS resources (e.g., NZP CSI-RS resources). In some embodiment, the CSI reporting configuration includes indications of one or more of the following reporting options as described below. In the below reporting options, a set of spatial domain basis vectors is denoted by W₁, a set of frequency domain basis vectors is denoted by W_{f}, and a set of combination coefficient is denoted by W₂.

In a first option, the CSI reporting configuration includes configurations for reporting indications of W₁ and W_{f} of Type II PMI, an indication of W₂ of Type II PMI for combining W₁ and W_{f}, time domain information such as a time domain correlation matrix of compressed beam-delay domain channel by W₁ and W_{f}.

In a second option, the CSI reporting configuration includes configurations for reporting indications of a time domain correlation matrix of compressed beam-delay domain channel by W₁ and W_{f}, where W₁ and W_{f} are from the previous CSI report.

In a third option, the CSI reporting configuration includes configurations for reporting indications of W₁ and W_{f} of Type II PMI and an indication of a plurality of sets of combination coefficients per layer (e.g., multiple W₂ of Type II PMI per layer). A layer herein refers to a transmission layer.

In a fourth option, the CSI reporting configuration includes configurations for reporting one or more sets of combination coefficients per layer (e.g., multiple W₂ of Type II PMI per layer).

In a fifth option, the CSI reporting configuration includes configurations for reporting only a time domain correlation matrix of compressed beam-delay domain channel.

In some of the above options of CSI reporting configuration, an indication of one W₂ or multiple instances of W₂ may need to be reported, depending on which option is selected by the network node. The one or multiple instances of W₂ may be for one or more previous time steps, one or more future time steps, or a combination of both.

In some embodiments, in addition to including configurations for reporting an indication of one of above options, the CSI reporting configuration includes additional parameters and/or indications of other content, such as RI, and CQI, precoding type indicator (PTI), layer indicator (LI), etc.

In some embodiments, the CSI reporting configuration further comprises configurations for reporting indications of one or more time steps over which the time-domain correlation matrix is determined and/or the quantity of the one or more time steps.

With reference still to FIG. 10, at step 1004, the UE receives the CSI reporting configuration from the network node. In the CSI reporting configuration, one or more options for reporting sets of content can be configured to be reported in the same report, which can be used by the network node for predicting a Type II PMI. In one example, the CSI reporting configuration can include lags (e.g., time gaps) and/or the number of lags over which the time domain correlation of compressed beam-delay domain channel is calculated.

As described above, at step 1002, the UE receives the configuration of CSI-RS resources for channel measurements. At step 1006, based on the received configuration, the UE performs channel measurements on the CSI-RS resources to determine the CSI, as described above.

At step 1008, the UE is further configured to determine a set of spatial domain basis vectors W₁ and a set of frequency domain vectors W_{f} of Type II PMI, and one or more W₂ of Type II PMI. For example, the UE can calculate an aggregated W_{f} that contains all unique FD basis vectors across all layers, which together with W₁ form the basis for calculating a compressed beam-delay domain channel.

At step 1010, the UE determines what is required in the CSI reporting configuration according to different options. For example, the first option described above requires reporting a set of spatial domain basis vectors, a set of frequency domain basis vectors, a set of combination coefficients (W₂) for combining the set of spatial domain basis vectors and the set of frequency domain basis vectors, and a time-domain correlation matrix. The third option described above requires reporting a set of spatial domain basis vectors, a set of frequency domain basis vectors, and a plurality of sets of combination coefficients per layer (multiple W₂s) for combining the set of spatial domain basis vectors and the set of frequency domain basis vectors for one or more time steps. When the UE determines that the third option is required (i.e., step 1010 is “no”), method 1000 goes to step 1016, at which the CSI report is sent to the network node, which is described in more detail below. When the UE determines that the first option is required (i.e., step 1010 is “yes”), the UE also performs the following determinations. In particular, the UE calculates (step 1012) the compressed beam-delay domain channel based on the obtained W₁ and W_{f}, and calculates (step 1014) the time domain correlation matrix of the obtained compressed beam-delay domain channel.

In some embodiments, the time domain correlation matrix of the compressed beam-delay domain channel, if reported, is quantized and approximated by a linear combination of a set of basis vectors. The set of basis vectors may be different from the SD basis vectors and the FD basis vectors. The set of basis vectors are for approximating, quantizing, and/or representing the time domain correlation matrix. Such basis vectors can include one or more of DFT vectors, wavelets, and Grassmannian codebook. In some embodiments, the basis vectors are eigenvectors of the correlation matrix, which are quantized and reported to the network node. In some embodiments, certain basis vectors are selected by the UE from the set of basis vectors and indices of the selected basis vectors and the corresponding combination coefficients (if reported) are reported to the network node.

In some embodiments, the time domain correlation matrix of the compressed beam-delay domain channel, if reported, is compressed and quantized using a machine-learning based autoencoder. For example, a trained neural network in the UE is used to compress the correlation matrix to a number of bits that are reported to the network node (e.g., a gNB). Further, the network node can use a matching trained neural network to reconstruct the time domain correlation matrix. In some embodiments, the neural network in the network node is trained to directly reconstruct the state transition matrix of the AR model. In some embodiments, when reporting indications of multiple time domain correlation matrices, differential encoding is used for reporting the difference between the time domain correlation matrices at different time steps. In some embodiments, when reporting multiple indications of W₂, differential encoding is used for reporting the difference between W₂ at different time steps.

Calculations of the compressed beam-delay domain channel and the time-domain correlation matrix are described in greater detail below.

It is understood that method 1000 shown in FIG. 10 is merely an illustration. Certain steps can be removed from method 1000; other steps can be added to the method 1000; or the steps can be duplicated or altered. For example, similar to the third option, the second option also requires reporting a time domain correlation matrix. Thus, steps 1012 and 1014 can be also used if the second option is selected for reporting.

At step 1016, the UE sends the CSI report to the network node. The content of the CSI report depends on which of the above options is configured. For example, the CSI report may include an indication of one of the set of combination coefficients (W₂) and an indication of the time-domain correlation matrix. The CSI report may alternatively include an indication of the plurality of sets of combination coefficients per layer for the one or more time steps (multiple W₂s). The mechanisms of the UE sending the CSI report containing indications of the Type II PMI are described in greater detail below.

At step 1018, the network node receives the CSI report from the UE. At step 1020, using the received CSI report, the network node determines the indication of the time-domain correlation matrix that is to be used for prediction of Type II PMI; and determines a predicted Type II PMI according to the indication of the time-domain correlation matrix. The indication of the time-domain correlation matrix and the prediction of the Type II PMI are described in greater detail below.

At step 1040, in some embodiments, based on the predicted Type II PMI, the network node constructs DL channel information for the current and/or a future slot. The constructed DL channel information can be used, for example, for PDSCH precoding or MU-MIMO scheduling.

The embodiments of the present disclosure may provide one or more of the following technical advantage(s). The described Type II CSI reporting enhancements enable the network node to predict a Type II PMI for a future time step or multiple future time steps. The predicted CSI reduces overhead for obtaining CSI, as well as provides additional robustness toward high mobility UEs.

The methods described herein apply to, but are not limited to, Rel-16 Type II (enhanced Type II or eType II) and Rel-17 Type II (further enhanced Type II or feType II) PMI or codebooks in 3GPP.

Furthermore, the TD correlation of certain types of channel properties is a long-term characteristic that does not vary rapidly over time. Therefore, a network node can combine a Type II PMI that is available at the current time with the TD correlation of some kind of channel information, and then predict a Type II PMI at a future time step by using, for example, Kalman filtering described above. This reduces the overhead of CSI reporting as well as CSI-RS transmission. The predicted Type II PMI can be used for co-scheduling of users for MU-MIMO, precoding for PDSCH transmission, and the like.

According to some embodiments, Type II PMI includes three components: W₁, W_{f} and W₂. As described above, W₁ represents the spatial domain basis vectors, which indicate which beam to use to compress the channel. W_{f} represents the frequency domain basis vectors, which indicate how to compress the frequency domain channel. And W₂ includes combination coefficients for combining different W₁ and W_{f} columns.

According to some embodiments, PMI prediction can be applied only on W₂ in the Type II CSI, because the spatial domain basis vectors W₁ and the frequency domain basis vectors W_{f} represent long term channel properties which do not change rapidly over time. Therefore, the predicted Type II PMI is constructed by keeping the W₁ and W_{f} as reported by the UE, while only updating and/or predicting W₂.

To enable the network node to predict W₂, indications or information about the TD correlation of certain types of channel information are provided. The TD correlation can be, for example, one of TD correlation of the compressed channel in the beam-delay domain or TD correlation of W₂ in Type II PMI.

As described above, at step 1314 of FIG. 10, a time-domain correlation matrix is determined. The details of determination of the time-domain correlation matrix are now described in greater detail.

In some embodiments, the TD correlation can be calculated based on a compressed channel in the beam-delay domain, which is much simpler than calculating the TD correlation based on the raw channel in the angle-frequency domain, due to the dimension reduction. More specifically, the UE calculates the spatial domain basis vectors W₁ and the frequency domain basis vectors W_{f}. Then, based on W₁ and W_{f}, the UE can compress the estimated DL channel from the angle-frequency domain to the beam-delay domain. For port-selection Type II codebooks, W₁ is a port selection matrix, which can also be treated as spatial domain basis vectors if taking CSI-RS precoding into account. To be concise, W₁ in port-selection Type II and in regular Type II is not differentiated in this disclosure.

In one example, the channel in the antenna-frequency domain between the network node and a single antenna UE is expressed as H_{af}∈ [symbol] ^{P×N}^{₃}, where P and N₃ denote the number of CSI-RS ports and subbands, respectively. The UE obtains the beam-delay domain channel via

$${H}_{bd} = {W}_{1} {H}_{af} {W}_{f}^{H} ∈ {ℂ}^{2 L \times M} ,$$

where L is the number of SD basis vectors (beams) selected for each polarization, and M is the number of FD basis vectors (taps). Usually, 2L can be much smaller than P, and M can be much smaller than N₃, thereby achieving dimension reduction.

The TD correlation with lag i of the beam-delay domain channel can be calculated as

$${R}_{{\underline{h}}_{bd} , i} = E [ {\underline{h}}_{bd , n} {\underline{h}}_{bd , n - i}^{H} ] ,$$

$$where$$

$${\underline{h}}_{bd , n} = vec ( {H}_{bd , n} ) and {H}_{bd , n}$$

denotes the beam-delay domain channel at time step n.

In Rel-16 Type II (i.e., eType II) CSI, W_{f} is layer specific. Calculating and reporting [symbol] for each individual layer can be redundant, since different layers may have overlapped FD basis vectors. In this case, for the calculation of TD correlation matrix, the UE can formulate an aggregated W_{f} by including all unique FD basis vectors across all layers. Then, the TD correlation for a given layer v, denoted by

$${R}_{{\underline{h}}_{bd} i}^{( v )} ,$$

can be easily extracted from the total TD correlation [symbol] .

In some embodiments, the TD correlation of W₂ in Type II PMI can be calculated.

In a Type II CSI report, e.g., Rel-16 Type II (eType II) and Rel-17 Type II (feType II), a pair of SD basis vector (a column from W₁) and FD basis vector (a column from W_{f}) can be considered to correspond to a propagation path with certain angle of departure (AoD) and delay, due to some cluster in the propagation environment. Each element in W₂ informs the network node how different paths should be co-phased and scaled in amplitude. Therefore, the TD correlation of W₂ is also a long-term channel property that do not change rapidly over time.

In some embodiments, the TD correlation of W₂ in a Type II PMI (e.g., Rel-16 eType II and Rel-17 feType II) is calculated and used by the network node to perform prediction of Type II PMI.

The TD correlation of W₂ in a Type II PMI with lag i can be calculated as R_{w2,i}=

$$E [ {\underline{w}}_{2 , n} {\underline{w}}_{2 , n - i}^{H} ] ,$$

$$where$$

$${\underline{w}}_{2 , n} = vec ( {W}_{2 , n} ) and {W}_{2 , n}$$

is the W₂ matrix in Type II PMI calculated for time step n.

The mechanisms of the UE sending the CSI report containing indications of the Type II PMI are (also referred to as the PMI feedback mechanism) are now described in greater details.

As described above, at step 1016 shown in FIG. 10, the UE sends a CSI report including indications of W₁ and W_{f}. Since W₁ and W_{f} reflect long-term channel properties, they can be assumed unchanged over the period of time where PMI prediction is conducted. Thus, it may be suffice to report W₁ and W_{f} only once when predicting a Type II PMI. Accordingly, in some embodiments, the FD basis indicator and SD basis indicator for Type II PMI is only reported once over the period of time where PMI prediction is conducted.

In some embodiments, when Type II CSI reporting is to be triggered aperiodically, then there is a need to indicate via downlink control information (DCI) when the UE should report W₁ and W_{f} (given that W₁ and W_{f} only need to be reported once when predicting a Type II PMI). Hence, in the DCI that triggers the aperiodic Type II CSI report, a new bit field can be introduced to indicate whether W₁ and W_{f} should be reported as part of the aperiodic Type II CSI report. If the new bit field is set to one codepoint (or one value), then W₁ and W_{f} should be reported as part of the aperiodic Type II CSI report. If the new bit field is set to another codepoint (or a second value), then W₁ and W_{f} should not be reported as part ot the aperiodic Type II CSI report.

In some embodiments, the UE can also report certain indications of the TD correlation matrix and W₂ as part of the CSI report.

Depending on which kind of TD correlation is used, i.e., either [symbol] or R_{w2,i} as explained above, the PMI feedback mechanism can be done in different ways. Regardless of which kind of TD correlation is used, the time steps (also referred to as lags) for which the correlation is measured and the number of lags, need to be known by both the network node and the UE. More specifically, if the TD correlation with lag i is denoted as Rᵢ, for i=1, . . . , p, where Rᵢ could be either [symbol] or R_{w2,i}, both p and the time gap over which Rᵢ is calculated need to be known.

In some embodiments, the number of lags p for which TD correlation should be measured, is configured by the network node via higher layer signaling (e.g., RRC signaling). In some embodiments, the number of lags p for which TD correlation should be measured is configured as an optional parameter by the network node to the UE. In some embodiments, if the parameter is not configured, then the UE assumes a particular number of lags p by default. In some embodiments, the default value for p, when the optional parameter is not configured is p=1. In this disclosure, the number of lags refers to number of time steps.

In some embodiments, the number of lags p for which TD correlation should be measured is a UE capability and is sent from the UE to the network node as a part of the UE capability reporting. The network node configures the number of lags p taking into account the reported capability from the UE.

In some embodiments, the number of lags p for which TD correlation should be measured, is pre-determined and commonly known by a network node and UE, e.g., specified in 3GPP standard.

In some embodiments, the number lags p for which TD correlation should be measured is indicated to the UE by the network node via a MAC control element (MAC CE). This MAC CE indicates the number of lags p for which TD correlation should be measured along with the CSI report configuration (or an ID or indicator of the CSI report configuration) for which the number of lags p should apply to. In some embodiments, the bandwidth part ID (BWP ID) and the serving cell ID correspond to the CSI reporting configuration for which the number of lags p are being updated. Before a first MAC CE that updates the number of lags p is received, the UE can assume a default number of lags (e.g., p=1).

The time gap over which Rᵢ is calculated for i=1, . . . , p can be known by the network node and UE through higher layer signaling (e.g., RRC), pre-determination and/or specification in 3GPP. In other embodiments, it can be inferred from CSI-RS resource configuration.

When the TD correlation is of compressed channel in the beam-delay domain, i.e., [symbol] , only the UE can calculate it, since the network node does not have access to the compressed channel in the beam-delay domain H_{bd,n}. Therefore, the UE needs to report [symbol] for i=1, . . . , p.

Reporting of [symbol] generally requires some compression mechanism, which can be achieved in multiple ways. In some embodiments, [symbol] is approximated by a linear combination of a set of basis vectors, and the indices of the selected basis vectors are reported by the UE to the network node. In addition, the associated linear combination coefficients may be quantized and reported by the UE to the network node. Such basis vectors can be discrete Fourier Transform (DFT) vectors, wavelets, Grassmannian codebook, etc.

In some embodiments, dominant eigenvectors of [symbol] (possibly also the associated eigenvalues) can be quantized and reported.

In some embodiments, only diagonal elements of [symbol] may be reported (after quantization).

Along with [symbol] , for i=1, . . . , p, W₂ also needs to be reported for the corresponding p time steps, so that the network node can combine this information to form a predicted W₂ Type II PMI for a future time step. For example, to predict W₂ at time step n (i.e., W_{2,n}), W_{2,n-1}, W_{2,n-2}, . . . , W_{2,n-p+1} need to be reported.

When the TD correlation is of W₂, i.e., R_{w2,i}, both the network node and UE can calculate it. Because the UE needs to send an indication of W₂ for p time steps to the network node, the network node can calculate the TD correlation matrix. In addition, calculating R_{w2,i} at the network node reduces UE complexity for such calculation. Also, it provides the network node with more freedom on how to use the W₂ feedback for the p time steps.

In some embodiments, based on the W₂ feedback for multiple time steps, the network node calculates R_{w2,i}. Based on R_{w2,i} and the reported W₂ for multiple time steps, the network node calculates a prediction of W₂, and thereafter a complete Type II PMI, for a future time step.

When W₂ for multiple time steps are reported to the network node, differential encoding can be used. For example, if W_{2,n-1}, W_{2,n-2}, . . . , W_{2,n-p+1} need to be reported, then only one of them need to be reported as the actual matrix, e.g., W_{2,n}, for the rest W_{2,n-2}, . . . , W_{2,n-p+1}, the UE only needs to report the difference relative to W_{2,n}. In this way, reporting overhead can be reduced.

As described above, at step 1320, the network node determines a type II PMI at a future time step based on the CSI report. The details of the PMI prediction is now described.

In some embodiments, the network node can perform the PMI prediction based on a TD correlation. Specifically, the prediction of W₂ for time step n (i.e., W_{2,n}) can be done by the network node based on W_{2,n-1}, W_{2,n-2}, . . . , W_{2,n-p+1} and the TD correlation Rᵢ (either [symbol] or R_{w2,i}) for i=1, . . . , p. For example, if the Kalman filter is used, firstly the AR parameters, \tilde{Φ}, as defined above, can be calculated based on Rᵢ. Then, \tilde{w}_{2,n} can be predicted as \tilde{w}_{2,n}=\tilde{Φ}\tilde{w}_{2,n-1}, where

$${\underline{\tilde{w}}}_{2 , n} = {[ \begin{matrix}{\underline{w}}_{2 , n}^{T} & ⋯ & {\underline{w}}_{2 , n - p + 1}^{T}\end{matrix} ]}^{T}$$

$$and$$

$${\underline{w}}_{2 , n} = vec ( {W}_{2 , n - 1} ) .$$

$$From {\underline{\tilde{w}}}_{2 , n} ,$$

the prediction W_{2,n} for time step n can be obtained. Finally, the whole Type II PMI for time step n can be predicted as

$${W}_{1} {W}_{2 , n} {W}_{f}^{H} .$$

In some embodiments, the network node can perform the PMI prediction directly based on the UE's report of W₂.

In some embodiments, the UE can also directly report prediction of W₂ for future time steps. Then the network node can directly predict based on the reported Type II PMI for the corresponding future time steps.

Functions described herein as being performed by a wireless device or a network node may be distributed over a plurality of wireless devices and/or network nodes.

The foregoing specification is to be understood as being in every respect illustrative and exemplary, but not restrictive, and the scope of the teachings disclosed herein is not to be determined from the specification, but rather from the claims as interpreted according to the full breadth permitted by the patent laws. It is to be understood that the embodiments shown and described herein are only illustrative of the principles of the present teachings and that various modifications may be implemented by those skilled in the art without departing from the scope and spirit of the invention. Those skilled in the art could implement various other feature combinations without departing from the scope and spirit of the teachings.

1. A method performed by a user equipment (UE) for channel state information (CSI) reporting, the method comprising:
receiving a configuration of one or more CSI reference signal (CSI-RS) resources for channel measurements;
performing the channel measurements on the one or more CSI-RS resources according to the received configuration;
determining one of:
a set of spatial domain basis vectors, a set of frequency domain basis vectors, a set of combination coefficients for combining the set of spatial domain basis vectors and the set of frequency domain basis vectors, and time-domain information;
a set of spatial domain basis vectors, a set of frequency domain basis vectors, and a plurality of sets of combination coefficients per layer for combining the set of spatial domain basis vectors and the set of frequency domain basis vectors for one or more time steps; and
sending a CSI report to the network node, the CSI report comprising an indication of one of the set of combination coefficients and an indication of the time-domain information, and, an indication of the plurality of sets of combination coefficients per layer for the one or more time steps.

2. The method of claim 1, further comprising receiving a CSI reporting configuration, the CSI reporting configuration indicating reporting an indication of one of the set of combination coefficients and an indication of the time-domain information, and, an indication of the plurality of sets of combination coefficients per layer for the one or more time steps.

3. The method of claim 2, when the CSI reporting configuration indicates reporting the indication of the set of combination coefficients and the indication of the time-domain information, further comprising:
determining a compressed beam-delay domain channel based on the set of spatial domain basis vectors and the set of frequency domain basis vectors; and
determining the time-domain information of the compressed beam-delay domain channel,
wherein the set of combination coefficients is computed for a single time step, and wherein the CSI report further comprises the indication of the set of spatial domain basis vectors and the indication of the set of frequency domain basis vectors.

4. The method of claim 2, wherein the CSI reporting configuration further comprises at least one of:
one or more time steps over which the time-domain information is determined; and
a quantity of the one or more time steps.

5. The method of claim 2, wherein the indication of the time-domain information comprises a quantization and approximation of a time-domain correlation matrix by a linear combination of a set of basis vectors.

6. The method of claim 5, wherein the set of basis vectors are discrete Fourier Transform (DFT) vectors.

7. The method of claim 5, wherein the indication of the time-domain information comprises indices of basis vectors selected from the set of basis vectors.

8. The method of claim 1, wherein the indication of the information comprises eigenvectors of a time-domain correlation matrix.

9. The method of claim 1, wherein the time-domain information is compressed and quantized by a neural network based autoencoder.

10. The method of claim 1, further comprising applying differential encoding to the plurality of sets of combination coefficients for at least some of the one or more time steps.

11. The method of claim 1, wherein at least one of the set of the combination coefficients or the plurality of sets of combination coefficients comprise combination coefficients for one or more previous time steps.

12. The method of claim 1, wherein at least one of the set of the combination coefficients or the plurality of sets of combination coefficients comprise predictions of combination coefficients for one or more future time steps.

13. The method of claim 1, wherein a time step of the one or more time steps corresponds to a resolution of one of the plurality of the sets of combination coefficients in a time domain.

14. A method performed by a network node for receiving a channel state information (CSI) report, the method comprising:
sending, to user equipment (UE), a configuration of CSI reference signal (CSI-RS) resources for channel measurements; and
receiving a CSI report from the UE, the CSI report comprising one of:
an indication of a set of spatial domain basis vectors, an indication of a set of frequency domain basis vectors, an indication of a set of combination coefficients for combining the set of spatial domain basis vectors and the set of frequency domain basis vectors, and an indication of time-domain information, or
an indication of a set of spatial domain basis vectors, an indication of a set of frequency domain basis vectors, and an indication of a plurality of sets of combination coefficients per layer for combining the set of spatial domain basis vectors and the set of frequency domain basis vectors for one or more time steps.

15. The method of claim 14, wherein, the time-domain information is determined for a compressed beam-delay domain channel which is determined based on the set of spatial domain basis vectors and the set of frequency domain basis vectors; and
the set of combination coefficients is determined for a single time step.

16. The method of claim 14, further comprising: sending a CSI reporting configuration to the UE, wherein the CSI reporting configuration comprises at least one of:
an indication of the one or more time steps over which the time-domain information is determined; and
an indication of a quantity of the one or more time steps.

17. The method of claim 14, wherein the indication of the time-domain information comprises a quantization and approximation of a time-domain correlation matrix by a linear combination of a set of basis vectors.

18. The method of claim 17, wherein the indication of the time-domain information comprises indices of basis vectors selected from the set of basis vectors.

19. The method of claim 14, wherein the indication of the time-domain information comprises eigenvectors of the time-domain correlation matrix.

20. (canceled)

21. (canceled)

22. (canceled)

23. (canceled)

24. (canceled)

25. (canceled)

26. (canceled)

27. User equipment for performing channel state information (CSI) reporting, comprising: a transceiver, a processor, and a memory, said memory containing instructions executable by the processor whereby the UE is operative to perform a method, the method comprising:
receiving a configuration of one or more CSI reference signal (CSI-RS) resources for channel measurements;
performing the channel measurements on the one or more CSI-RS resources according to the received configuration;
determining one of:
a set of spatial domain basis vectors, a set of frequency domain basis vectors, a set of combination coefficients for combining the set of spatial domain basis vectors and the set of frequency domain basis vectors, and time-domain information;
a set of spatial domain basis vectors, a set of frequency domain basis vectors, and a plurality of sets of combination coefficients per layer for combining the set of spatial domain basis vectors and the set of frequency domain basis vectors for one or more time steps; and
sending a CSI report to a network node, the CSI report comprising an indication of one of the set of combination coefficients and an indication of the time-domain information, and, an indication of the plurality of sets of combination coefficients per layer for the one or more time steps.

28. (canceled)

29. (canceled)
